(19) United States
(12) Patent Application Publication
(10) Pub. No.: US 2020/0162172 A1
(43) Pub. Date: May 21, 2020

(54) Physical-Layer Security for Coherent Communications System

(71) Applicant: Ciena Corporation, Hanover, MD (US)

(72) Inventors: Balakrishnan SRIDHAR, Ellicott City, MD (US); John P. MATEOSKY, West River, MD (US); Michael Y. FRANKEL, Bethesda, MD (US)

(21) Appl. No.: 16/198,464

(22) Filed: Nov. 21, 2018

(51) Int. Cl. H04B 10/85; H04B 10/61; H04B 10/516; H04L 1/00

(52) U.S. Cl. CPC H04B 10/85; H04L 1/0041; H04B 10/5161; H04B 10/6162

(57) ABSTRACT

Physical-layer security is provided by obfuscating or concealing the structure of the signal being transmitted, such that recovery of the underlying information is prohibitively expensive or even impossible. A digital filter implemented within a digital signal processor at the transmitter device introduces an obfuscation function. A digital filter implemented within a digital signal processor at the receiver device removes the obfuscation function. The obfuscation function conceals information bits to be conveyed by a modulated carrier signal. In some versions, the obfuscation function digitally modifies the phases of individual frequency components of the drive signals used to generate the modulated carrier signal. In other versions, the obfuscation function digitally modifies the phases and amplitudes of individual frequency components of the drive signals used to generate the modulated carrier signal.

### TECHNICAL FIELD

This document relates to the technical field of physical-layer security in a coherent communications system.

### BACKGROUND

In a typical optical transport system, the data can be encrypted digitally in the transmitter using a key and decrypted at the receiver with the key. The key is changed periodically, and the new key may be transmitted through the same channel or through an out of band connection. Alternatively, any suitable key-agreement protocol can be used to ensure that the transmitter and the receiver have the same key. The optical line and the fiber traverse vast distances and are hard to secure physically. A simple optical tap can be used to obtain a copy of the transmitted signal. The copy of the transmitted signal can be easily detected and decoded by a similar receiver, and possibly stored for offline decryption. Even though the encryption layer can secure the data from being decrypted, it is vulnerable to offline brute force methods, or methods that look for the key in link data or look for a known data signature for key extraction.

Some systems deploy block ciphers such as Advanced Encryption Standard (AES) encryption implemented in what is known as counter mode to accommodate the very high throughput required for modern optical networks. The block cipher is often coupled with a companion authentication algorithm such as Galois/Counter Mode (GCM). This suite of bulk encryption/decryption is quite gate intensive and presents a series of challenges associated with key distribution, application and maintenance. Counter mode bulk encryption and decryption with built-in authentication, similar to AES-GCM and others, is gate and power intensive, and as power becomes more and more of an issue in the coherent Digital Signal Processor (DSP) Application Specific Integrated Circuit (ASIC) market with the advent of pluggable optical transceivers, many times the decision whether to include or to omit an AES encryption engine comes down to considerations of power consumption, die area, and other systems issues.

J. Cho et al., Experimental demonstration of physical-layer security in a fiber-optic link by information scrambling, ECOC 2016, proposes to encrypt optical signals at the physical layer using a Linear Feedback Shift Register (LFSR) in the modem DSP. This method adds a short (256-bit) LFSR prior to the FEC encoder on the transmitter side, and its pair LFSR after the FEC decoder on the receiver side. If the FEC decoder provides zero errors, the LFSR delivers original signals. However, an eavesdropper is assumed to experience somewhat worse performance, and the FEC dribbles errors producing catastrophic error multiplication by the LFSR and data bit output indistinguishable from noise. This approach is limited by requiring the eavesdropper to have marginally worse performance than the intended recipient, and by being susceptible to plaintext attacks. This is difficult to assure in a link where there is a large SNR change between the transmitter and receiver of the channel, that is, in long links, the intended recipient may have channel performance that is much worse than an eavesdropper positioned close to the transmitter.

M. A. Brandau, Implementation of a real-time voice encryption system, Master Thesis, Universitat Politecnica de Catalunya, February 2008, proposes a frequency scrambling technique by effectively decomposing the signal into frequency sub-bands and pseudo-randomly re-arranging them in the frequency domain. The number of sub-bands that can be achieved in practice is fairly small, and signal decryption can be easily accomplished via a brute force attack.

The use of Finite Impulse Response (FIR) filters for concealing voice signals is well known. U.S. Pat. No. 5,101,432 applied FIR filters to encryption of analog voice signals. The use of FIR filter encryptors and Infinite Impulse Response (IIR) filter decryptors is also described in M. Petrovic, Digital signal filtering as a method of data encryption, IEESTEC 2014 conference.

N. Kostinski et al., Demonstration of an all-optical OCDMA encryption and decryption system with variable two-code keying, IEEE Phot. Techn. Lett., vol. 20, no. 24, December 2008, pp. 2045-2047, describes use of Optical Code-Division Multiple Access (OCDMA) techniques with an all-optical encryptor and an all-optical decryptor. The proposal uses a time-domain based operation of taking data and applying a XOR with a much larger bit-rate chip key. The signal is therefore both spread in frequency providing concealment and encrypted with the key. In principle, this technique could be implemented in a DSP.

An approach referred to as AlphaEta (αη) relies on expansion of a modulation constellation around a phase rotation. This approach is discussed in R. Nair et al., Quantum Noise Randomized Ciphers, Physical Review A—Atomic, Molecular, and Optical Physics, 2006, vol. 74, no. 5. This approach is also discussed in H. P. Yuen et al., On the security of al: response to ‘some attacks on quantum-based cryptographic protocols’, Quantum Information and Computation, 2006, vol. 6, no. 7, pp. 561-582. For example, a binary phase-shift key (BPSK) signal is recoded by a key into a discrete multi-valued function with phase distributed throughout the 0 to π space, that is, a multi-valued PSK constellation around an I/Q plane ring. The addition of optical noise obscures the data points, such that the received constellation looks like a continuous donut in the I/Q space, and original bits cannot be recovered without knowledge of the key. The described implementation is restricted purely to time-domain discrete phase modulation and uses an external optical phase modulator for implementation of both encoding and decoding functions. Noise is generated by an external optical source, such as an EDFA amplifier.

M. Nakazawa et al., QAM quantum stream cypher using digital coherent optical transmission, Optics Express, vol. 22, no. 4, 2014, pp. 4098-4107 expands on the αη concept. It uses a higher basis like 16-QAM to encode data, then uses a two-dimensional cypher to expand the constellation density to 1024-QAM. In this example, 4 bits of data (16QAM) is encrypted within 10 bits of output, and the decision level of the eavesdropper is thereby hidden by noise. The encryption is performed in the DSP, and subsequent ASE noise (added by an EDFA) hides the signal within optical phase and amplitude noise.

Another approach involves over sampling, which spreads the frequency spectrum, and time-domain phase modulation. This approach is described in T. Yeminy et al., Spectral and temporal stealthy fiber-optic communication using sampling and encoding, Optics Express, vol. 19, no. 21, 2011, pp. 20182-20198, and in E. Wohlgemuth et al., Demonstration of coherent stealthy and encrypted transmission for data center interconnection, Optics Express, vol. 26, no. 6, 2018, pp. 7638-7645. The proposal describes the approach as implemented partially in a DSP and partially in an external modulator, or alternatively as implemented fully in a DSP. The DSP-based portion oversamples the input signal, such that multiple frequency-domain replicas are obtained. The signal is therefore substantially spread in the frequency domain, increasing bandwidth. Time-domain phase modulation (DSP-based or by an external modulator) provides further encryption. At the receiver, the phase is decrypted by an inverse process, and Signal to Noise Ratio (SNR) is improved by coherent addition of multiple spectral sub-bands which carry the same data—the data is added coherently, while the noise is added incoherently, thereby improving the received SNR.

### SUMMARY

This document proposes providing an additional layer of security by obfuscating or concealing the structure of the signal being transmitted, such that recovery of the underlying information is prohibitively expensive or even impossible. A digital filter implemented within a digital signal processor at the transmitter device introduces an obfuscation function. A digital filter implemented within a digital signal processor at the receiver device removes the obfuscation function. The obfuscation function conceals information bits to be conveyed by a modulated carrier signal. In some versions, the obfuscation function digitally modifies the phases of individual frequency components of the drive signals used to generate the modulated carrier signal. In other versions, the obfuscation function digitally modifies the phases and amplitudes of individual frequency components of the drive signals used to generate the modulated carrier signal. The digital filter implemented at the transmitter device may have been designed for purposes other than obfuscation, for example, one or more of pre-compensation of impairments, calibration, and pre-distortion, and may be modified to introduce the obfuscation function. The digital filter implemented at the receiver device may have been designed for purposes other than obfuscation, for example, post-compensation of impairments, and may be modified to remove the obfuscation function. The impairments may be physical-layer impairments induced by the link between the transmitter device and the receiver device. Alternatively, the digital filters implemented at the transmitter device and at the receiver device may be designed specifically for introduction and removal of the obfuscation function, respectively.

### BRIEF DESCRIPTION OF THE DRAWINGS

FIG. 1 illustrates an example coherent communications system;

FIGS. 2, 4, 6, and 8 illustrate functionality of various example transmitter digital signal processors;

FIGS. 3, 5, 7, and 9 illustrate functionality of various example receiver digital signal processors;

FIG. 10 illustrates example deterministic phase offset results and example deterministic amplitude mapping results;

FIG. 11 illustrates achievable payload spectral efficiency with soft decision forward error correction (FEC) for different constellation cardinalities as a function of symbol energy to noise ratio (E_{S}/N₀); and

FIG. 12 illustrates an example coherent optical communications system using polarization-division multiplexing (PDM).

### DETAILED DESCRIPTION

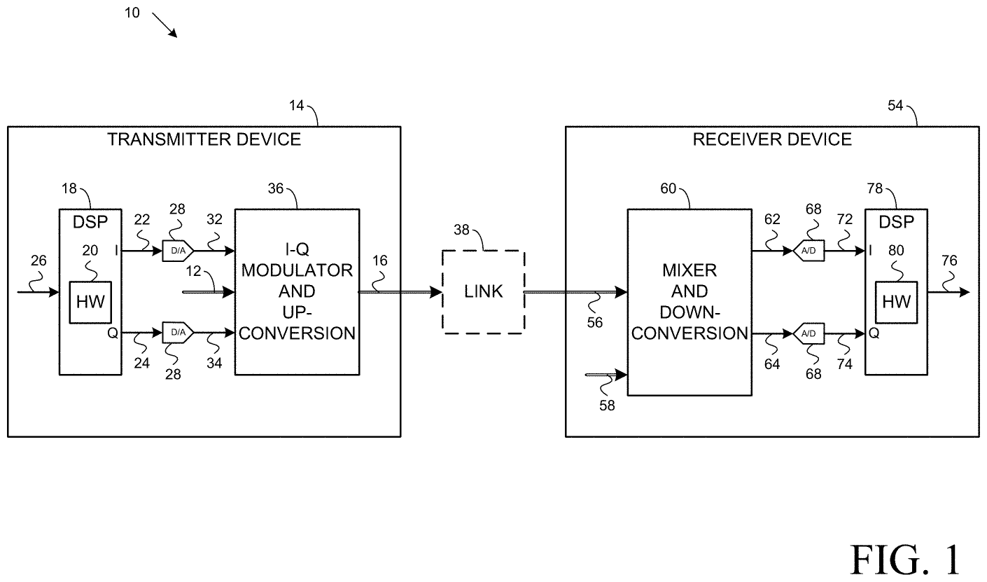

FIG. 1 illustrates an example coherent communications system 10 that uses phase modulation (and optionally amplitude modulation) of a carrier signal 12 to convey information.

A transmitter device 14 (“transmitter 14”) in the example coherent communications system 10 modulates the carrier signal 12 to produce a modulated carrier signal 16. A digital signal processor (DSP) 18 in the transmitter 14 generates in-phase (I) digital drive signals 22 and quadrature (Q) digital drive signals 24 from information bits 26. Digital-to-analog converters 28 convert the I/Q digital drive signals 22, 24 into respective I/Q analog drive signals 32, 34. The I/Q analog drive signals 32, 34 drive one or more I-Q modulators 36 that modulate the carrier signal 12 to produce the modulated carrier signal 16. The modulated carrier signal 16, which conveys the information bits 26, is then transmitted on a link 38. For simplicity, additional components of the transmitter 14 such as amplifiers are not illustrated or discussed in this document.

The information bits 26 to be conveyed by the modulated carrier signal 16 do not necessarily have any particular underlying spectral structure. The information bits 26 may be completely arbitrary. The information bits 26 may be encrypted data bits resulting from the application of conventional encryption techniques (with or without built-in authentication).

A rogue coherent receiver (not shown) coupled to the link 38 may obtain a copy of the modulated carrier signal 16 for the purpose of determining the information bits 26. Even in cases where the information bits 26 are encrypted data bits resulting from the application of conventional encryption techniques (with or without built-in authentication), the copy of the modulated carrier signal may be vulnerable to offline brute force methods without further levels of protection as proposed in this document.

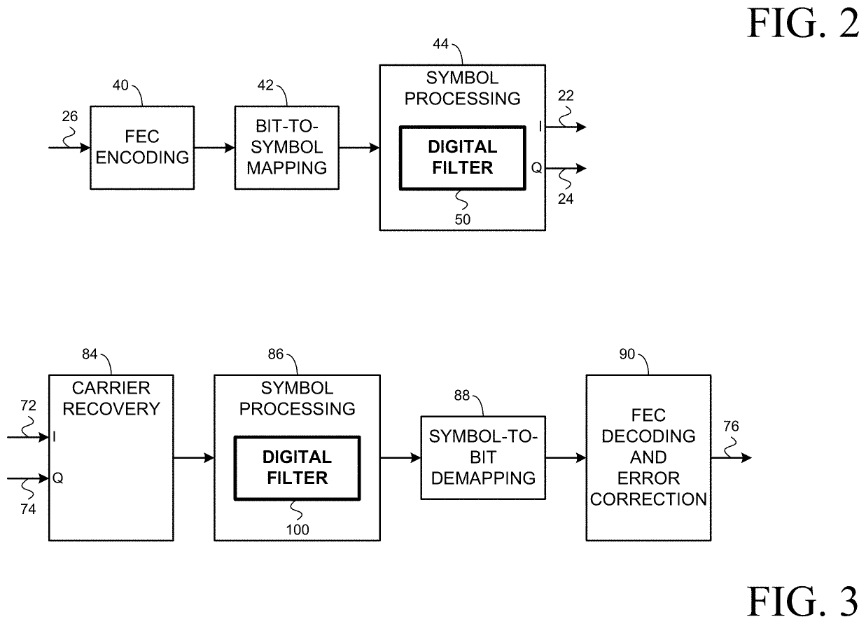

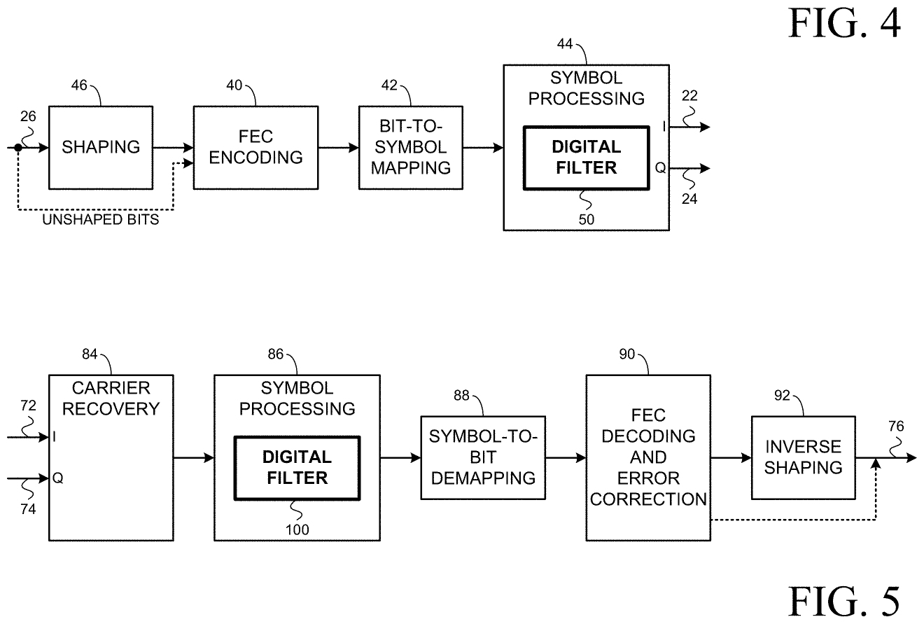

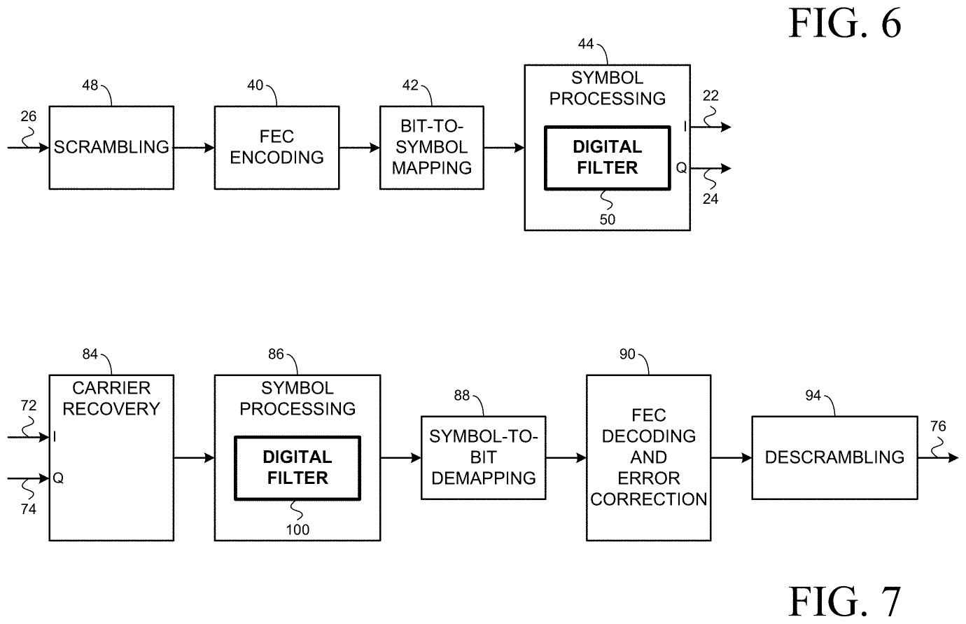

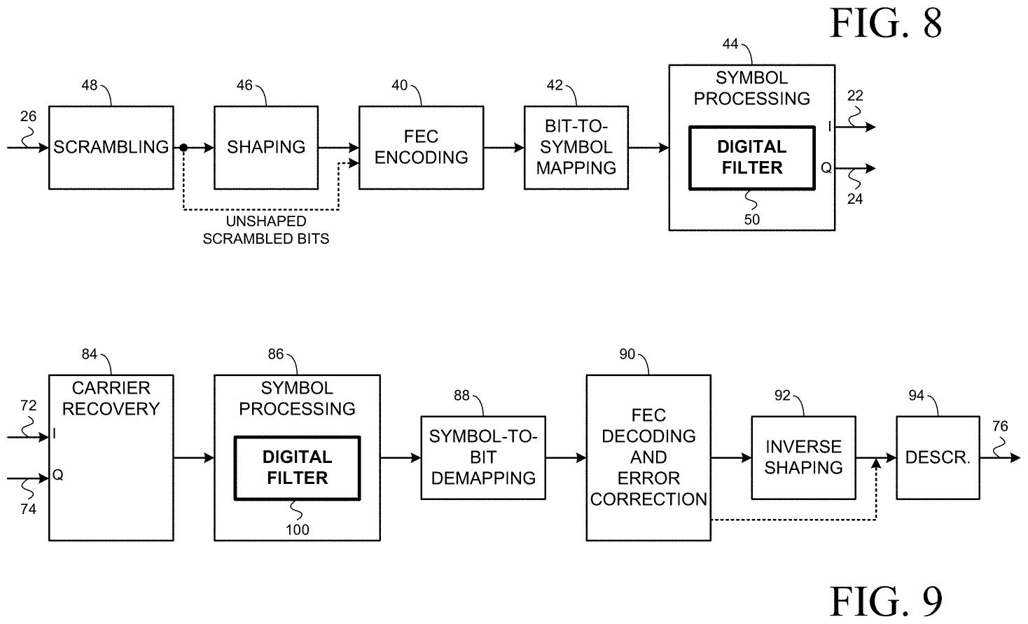

The transmitter DSP 18 is digital hardware 20 supported by software/firmware stored in a memory (not shown). Examples of the functionality implemented by the transmitter DSP 18 are illustrated in FIG. 2, FIG. 4, FIG. 6, and FIG. 8. In all of these examples, the functionality includes forward error correction (FEC) encoding 40, mapping 42 of FEC-encoded bits to symbols of a constellation, processing 44 of the symbols, and extraction of the I/Q digital drive signals 22, 24. If the processing 44 of the symbols were to leave the symbols unchanged, then the I/Q digital drive signals 22, 24 would be the I/Q components, respectively, of the symbols to which the FEC-encoded bits are mapped. In practice, however, the processing 44 of the symbols results in digital drive signals 22, 24 that—despite being labeled I and Q, respectively—do not necessarily represent I/Q components of symbols of the constellation.

In the example illustrated in FIG. 2, the FEC encoding 40 is applied to the information bits 26.

In the example illustrated in FIG. 4, the functionality implemented by the transmitter DSP 18 includes probabilistic constellation shaping (PCS) 46. All or a portion of the information bits 26 are shaped. The FEC encoding 40 is applied to the shaped information bits and, as indicated by a dotted arrow, to any remaining portion of the information bits 26. The bits of the remaining portion are unshaped. Systematic FEC encoding 40 preserves the shaping of the shaped information bits.

In the example illustrated in FIG. 6, the functionality implemented by the transmitter DSP 18 includes scrambling 48 of the information bits 26 prior to FEC encoding 40 of the scrambled information bits.

In the example illustrated in FIG. 8, the functionality implemented by the transmitter DSP 18 includes scrambling 48 of the information bits 26 to yield scrambled information bits, and probabilistic constellation shaping (PCS) 46. All or a portion of the scrambled information bits are shaped. The FEC encoding 40 is applied to the shaped scrambled information bits and, as indicated by a dotted arrow, to any remaining portion of the scrambled information bits which are unshaped. Systematic FEC encoding 40 preserves the shaping of the shaped scrambled information bits.

Returning now to FIG. 1, a receiver device 54 (“receiver 54”) in the example coherent communications system 10 generates a local version 58 of the carrier signal 12. The receiver 54 is operative to receive a received modulated carrier signal 56. The received modulated carrier signal 56 is a distorted version of the modulated carrier signal 16 that was transmitted by the transmitter 14. A mixer and down-conversion module 60 mixes the local version 58 of the carrier signal with the received modulated carrier signal 56 to detect the received modulated carrier signal 56. The outputs of the mixer and down-conversion module 60 are I/Q analog signals 62, 64. Analog-to-digital converters 68 sample the I/Q analog signals 62, 64 to yield respective I/Q digital signals 72, 74. A DSP 78 in the receiver 54 processes the I/Q digital signals 72, 74 to yield recovered bits 76. For simplicity, additional components of the receiver 54 such as amplifiers are not illustrated or discussed in this document.

In an ideal coherent communications system 10, the recovered bits 76 are identical to the information bits 26. In practice, however, impairments in the transmitter 14, the link 38, and the receiver 54 cause errors in the recovered bits 76.

The receiver DSP 78 is digital hardware 80 supported by software/firmware stored in a memory (not shown). Examples of the functionality implemented by the receiver DSP 78 are illustrated in FIG. 3, FIG. 5, FIG. 7, and FIG. 9. In all of these examples, the functionality includes carrier recovery 84 which identifies the “symbols” from the I/Q digital signals 72, 74, processing 86 of the “symbols” to yield processed symbols belonging to the constellation used in the mapping 42, de-mapping 88 of the processed symbols to FEC-encoded bits according to the constellation used in the mapping 42, and FEC decoding and error-correction 90 of the FEC-encoded bits. As explained above, in practice, the I/Q digital signals 72, 74—despite being labeled I and Q, respectively—do not necessarily represent I/Q components of symbols of the constellation.

In the example illustrated in FIG. 3, the FEC decoding and error-correction 90 yields the recovered bits 76.

In the example illustrated in FIG. 5, the functionality implemented by the receiver DSP 78 includes inverse probabilistic constellation shaping (PCS) 92 of all or a portion of the error-corrected FEC-decoded bits to yield the recovered bits 76. A dotted arrow indicates that the recovered bits 76 include any remaining portion of the error-corrected FEC-decoded bits that do not require inverse shaping.

In the example illustrated in FIG. 7, the functionality implemented by the receiver DSP 78 includes descrambling 94 of the error-corrected FEC-decoded bits to yield the recovered bits 76.

In the example illustrated in FIG. 9, the functionality implemented by the receiver DSP 78 includes descrambling 94 to yield the recovered bits 76, and inverse PCS 92. The inverse PCS 92 is applied to all or a portion of the error-corrected FEC decoded bits. The descrambling 94 is applied to the output of the inverse PCS 92 and, as indicated by a dotted arrow, to any remaining portion of the error-corrected FEC decoded bits that do not require inverse shaping.

Assuming the bits to be mapped to symbols of a constellation have no particular underlying structure, each one of the M symbols of the constellation has the same visitation probability equal to 1/M. Probabilistic constellation shaping (PCS) is a technique that allows control over the visitation probabilities of different constellation symbols, yielding unequal visitation probabilities. PCS allows the number of bits per symbol (sometimes referred to as the “capacity” or the “spectral efficiency”) to be varied in a (nearly) continuous manner without requiring support for multiple discrete constellations to be implemented. When the probability distribution of the visitation probabilities is Gaussian, PCS improves the linear noise tolerance relative to standard modulation. Various PCS implementations are known in the art, including, for example, the implementations described in U.S. Pat. No. 9,698,939. Development of new PCS implementations is ongoing.

Scrambling 48 and descrambling 94 may employ a linear feedback shift register (LFSR), for example, as described in J. Cho et al., Experimental demonstration of physical-layer security in a fiber-optic link by information scrambling, ECOC 2016. The background of this document explains that one limitation of the approach described in the ECOC 2016 article is that the eavesdropper is required to have marginally worse performance than the intended recipient, which is difficult to assure in a link where there is a large SNR change between the transmitter and the receiver of the channel. In contrast, use of LFSR for scrambling 48 in the transmitter DSP 18 as illustrated in FIG. 6 and FIG. 8 and use of LFSR for descrambling 92 in the receiver DSP 78 as illustrated in FIG. 7 and FIG. 9 is effective even when the eavesdropper has much better SNR performance than the intended recipient, because the additional obfuscation techniques that are employed force much higher error rates for the eavesdropper. Alternatively, scrambling 48 may employ an interleaver and descrambling 94 may employ a companion de-interleaver.

In examples where the transmitter DSP 18 implements the functionality illustrated in FIG. 2, the receiver DSP 78 implements the functionality illustrated in FIG. 3.

In examples where the transmitter DSP 18 implements the functionality illustrated in FIG. 4, the receiver DSP 78 implements the functionality illustrated in FIG. 5, so that the probabilistic constellation shaping (PCS) 46 performed in the transmitter DSP 18 is reversed by the inverse PCS 92 in the receiver DSP 78.

In examples where the transmitter DSP 18 implements the functionality illustrated in FIG. 6, the receiver DSP 78 implements the functionality illustrated in FIG. 7, so that the scrambling 48 performed in the transmitter DSP 18 is reversed by the descrambling 94 performed in the receiver DSP 78.

In examples where the transmitter DSP 18 implements the functionality illustrated in FIG. 8, the receiver DSP 78 implements the functionality illustrated in FIG. 9, so that the probabilistic constellation shaping (PCS) 46 performed in the transmitter DSP 18 is reversed by the inverse PCS 92 in the receiver DSP 78 and the scrambling 48 performed in the transmitter DSP 18 is reversed by the descrambling 94 performed in the receiver DSP 78.

The transmitter DSP 18 includes a digital filter 50 as part of the symbol processing 44, and the receiver DSP 78 includes a digital filter 100 as part of the symbol processing 86. The digital filters 50, 100 may both be implemented as a feed-forward filter, also known as a finite impulse response (FIR) filter. Alternatively, the digital filters 50, 100 may both be implemented as a feedback filter, also known as an infinite impulse response (IIR) filter.

This document proposes introducing an obfuscation function via the digital filter 50 at the transmitter 14 and removing the obfuscation function via the digital filter 100 at the receiver 54. The obfuscation function conceals the information bits 26 to be conveyed by the modulated carrier signal 16. In some versions, the obfuscation function digitally modifies the phases of individual frequency components of the drive signals used to generate the modulated carrier signal 16. In other versions, the obfuscation function digitally modifies the phases and amplitudes of individual frequency components of the drive signals used to generate the modulate carrier signal 16.

In the following discussion, the digital filters 50,100 are described in terms of their respective frequency-domain transfer functions. Equivalently, the digital filters 50,100 may be implemented in the time domain instead of in the frequency domain.

The digital filter 50 is characterized by its frequency-domain transfer function H_{TX}(ω), and the digital filter 100 is characterized by its frequency-domain transfer function H_{RX}(ω). An algorithm in the software/firmware of the transmitter DSP 18 determines the values of coefficients used by the digital filter 50, where the coefficients are a discrete representation of the frequency-domain transfer function H_{TX}(ω). An algorithm in the software/firmware of the receiver DSP 78 determines the values of coefficients used by the digital filter 100, where the coefficients are a discrete representation of the frequency-domain transfer function H_{RX}(ω).

The digital filters 50, 100 may be designed for a purpose other than obfuscation and modified as proposed in this document to introduce and remove the obfuscation function, respectively. For example, the digital filter 100 may be designed to apply post-compensation of one or more impairments as expressed by a frequency-domain transfer function H_{POST}(ω). For example, the digital filter 50 may be designed to apply pre-compensation of one or more impairments as expressed by a function H_{PRE}(ω), or to apply calibration of various analog and/or RF components in the transmitter 14 as expressed by a function R(ω), or to apply pre-distortion, or any combination thereof. The analog and/or RF components may include, for example, one or more of analog-to-digital converters, digital-to-analog converters, and the like. Calibration settings are typically fixed in the factory and manifest as DC pedestal offsets and bias settings.

The techniques described in this document are applicable to a wide range of coherent communication systems, including, but not limited to, coherent radio-frequency wireless communication systems, and coherent optical communications systems.

In the case of a coherent radio-frequency wireless communications system, impairments may include physical-layer impairments such as multi-path fading.

In the case of a coherent optical communications system, impairments may include physical-layer impairments such as chromatic dispersion (CD) and polarization-mode dispersion (PMD), polarization-dependent loss (PDL), and passband narrowing due to filtering. Linear impairments such as polarization mode dispersion (PMD) and chromatic dispersion can be corrected completely using an adaptive linear equalizer if the magnitude of the impairment is within the compensating range of the coherent optical receiver. Other impairments, such as polarization-dependent loss (PDL), cannot be completely compensated.

Chromatic dispersion (CD) in an optical fiber impairs the transmitted waveform E_{TX}(ω) so that the received waveform E_{RX}(ω) is approximated by E_{RX}(ω)=E_{RX}(ω)exp(−½ j β₂ D ω²), where j is the square root of −1, β² is the group velocity dispersion (GVD) parameter of the optical fiber, D is the length of the optical fiber, and ω is the modulation frequency component of the data signal. In the event that CD is handled entirely via an impairment pre-compensation algorithm used by the transmitter DSP 18, the frequency-domain transfer function that applies pre-compensation of CD may be expressed as H_{PRE}(ω)=exp(+½ j β₂ D ω²), and the frequency-domain transfer function H_{POST}(ω) may be the unitary operator. In the event that CD is handled partially via an impairment pre-compensation algorithm used by the transmitter DSP 18 and partially via an impairment post-compensation algorithm used by the receiver DSP 78, the combined effect of H_{PRE}(ω) and H_{POST}(ω) may be expressed as

H_{PRE}(ω)*H_{POST}(ω)=exp(+½jβ₂ Dω²).

Alternatively, the digital filters 50, 100 may be designed specifically for introduction and removal of the obfuscation function, respectively.

In some versions, the obfuscation function digitally modifies the phases of individual frequency components of the drive signals used to generate the modulated carrier signal 16. For example, the frequency-domain transfer function that characterizes the digital filter 50 may be set to H_{TX}(ω)=H_{PRE}(ω)*R(ω)*P(ω) or to H_{TX}(ω)=H_{PRE}(ω)*P(ω) or to H_{TX}(ω)=R(Ω)*P(ω) or to H_{TX}(ω)=P(ω), where P(ω) is a deterministic phase mapping. A pseudorandom phase mapping P(ω) effectively remaps a discrete data constellation into a continuous signal without identifiable constellation points. Stated differently, the pseudorandom phase mapping P(ω) ensures that the symbols to which the FEC-encoded bits were mapped cannot be identified from the digital drive signals 22, 24 that are output from the digital filter 50 without precise knowledge of the pseudorandom phase mapping.

The digital filter 50, when characterized by the frequency-domain transfer function H_{TX}(ω)=H_{PRE}(ω)*R(ω)*P(ω), applies pre-compensation of the impairment and calibration of analog and/or RF components and introduces deterministic phase mapping to obscure the signal structure such that it is indistinguishable from random noise.

The digital filter 50, when characterized by the frequency-domain transfer function H_{TX}(ω)=H_{PRE}(ω)*P(ω), applies pre-compensation of the impairment and introduces deterministic phase mapping to obscure the signal structure such that it is indistinguishable from random noise.

The digital filter 50, when characterized by the frequency-domain transfer function H_{TX}(ω)=R(ω)*P(ω), applies calibration of analog and/or RF components and introduces deterministic phase mapping to obscure the signal structure such that it is indistinguishable from random noise.

The digital filter 50, when characterized by the frequency-domain transfer function H_{TX}(ω)=P(ω), introduces deterministic phase mapping to obscure the signal structure such that it is indistinguishable from random noise.

The deterministic phase mapping P(ω) introduced by the digital filter 50 does not destroy input signal information and is completely invertible. In the event that the frequency-domain transfer function that characterizes the digital filter 100 is set to H_{RX}(ω)=H_{POST}(ω)*P(ω)⁻¹ or to H_{RX}(ω)=P(ω)⁻¹, where P(ω)⁻¹ is the inverse of P(ω), the signal is hidden at the transmitter and recovered at the receiver without signal loss.

The digital filter 100, when characterized by the frequency-domain transfer function H_{RX}(ω)=H_{POST}(ω)*P(ω)⁻¹, applies post-compensation of the impairment and deterministic phase de-mapping to uncover the signal structure.

The digital filter 100, when characterized by the frequency-domain transfer function H_{RX}(ω)=P(ω)⁻¹, applies deterministic phase de-mapping to uncover the signal structure.

In other versions, the obfuscation function digitally modifies the phases and amplitudes of individual frequency components of the drive signals used to generate the modulated carrier signal 16. For example, the frequency-domain transfer function that characterizes the digital filter 50 may be set to H_{TX}(ω)=H_{PRE}(ω)*R(ω)*P(ω)*A(ω) or to H_{TX}(ω)=H_{PRE}(ω)*P(ω)*A(ω) or to H_{TX}(ω)=R(ω)*P(ω)*A(ω) or to H_{TX}(ω)=P(ω)*A(ω), where P(ω) is a deterministic phase mapping and A(ω) is a deterministic amplitude mapping. A pseudorandom phase mapping P(ω) effectively remaps a discrete data constellation into a continuous signal without identifiable constellation points. Stated differently, the pseudorandom phase mapping P(ω) ensures that the symbols to which the FEC-encoded bits were mapped cannot be identified from the digital drive signals 22, 24 that are output from the digital filter 50 without precise knowledge of the pseudorandom phase mapping. The deterministic amplitude mapping may emulate noise, for example, additive Gaussian white noise (AWGN).

The digital filter 50, when characterized by the frequency-domain transfer function H_{TX}(ω)=H_{PRE}(ω)*R(ω)*P(ω)*A(ω), applies pre-compensation of the impairment and calibration of analog and/or RF components and introduces deterministic phase mapping and deterministic amplitude mapping to obscure the signal structure such that it is indistinguishable from random noise.

The digital filter 50, when characterized by the frequency-domain transfer function H_{TX}(ω)=H_{PRE}(ω)*P(ω)*A(ω), applies pre-compensation of the impairment and introduces deterministic phase mapping and deterministic amplitude mapping to obscure the signal structure such that it is indistinguishable from random noise.

The digital filter 50, when characterized by the frequency-domain transfer function H_{TX}(ω)=R(ω)*P(ω)*A(ω), applies calibration of analog and/or RF components and introduces deterministic phase mapping and deterministic amplitude mapping to obscure the signal structure such that it is indistinguishable from random noise.

The digital filter 50, when characterized by the frequency-domain transfer function H_{TX}(ω)=P(ω)*A(ω), introduces deterministic phase mapping and deterministic amplitude mapping to obscure the signal structure such that it is indistinguishable from random noise.

The deterministic phase mapping P(ω) introduced by the digital filter 50 does not destroy input signal information and is completely invertible. However, the deterministic amplitude mapping A(ω) introduced by the digital filter 50 leads to information loss of a magnitude that is related to A(ω). The deterministic amplitude mapping A(ω) is only partially invertible by the intended recipient. It is not completely invertible, as it results in noise amplification at the receiver. In the event that the frequency-domain transfer function that characterizes the digital filter 100 is set to H_{RX}(ω)=H_{POST}(ω)*P(ω)⁻¹*A(ω)⁻¹ or to H_{RX}(ω)=P(ω)⁻¹*A(ω)⁻¹, where P(ω)⁻¹ is the inverse of P(ω) and A(ω)⁻¹ is the partial inverse of A(ω), the signal structure is hidden at the transmitter and recovered at the receiver with some signal loss.

The digital filter 100, when characterized by the frequency-domain transfer function H_{RX}(ω)=H_{POST}(ω)*P(ω)⁻¹*A(ω)⁻¹ applies post-compensation of the impairment and deterministic phase de-mapping and deterministic amplitude de-mapping to uncover the signal structure.

The digital filter 100, when characterized by the frequency-domain transfer function H_{RX}(ω)=P(ω)⁻¹*A(ω)⁻¹, applies deterministic phase de-mapping and deterministic amplitude de-mapping to uncover the signal structure.

Deterministic phase mapping does not inherently spread the spectrum. Deterministic phase mapping with deterministic amplitude mapping does not inherently spread the spectrum, as both are applied in the frequency domain to individual spectral components and no new spectral components are generated.

Consider a scenario where the digital filter 50 uses 1152 coefficients to represent the frequency-domain transfer function H_{TX}(ω), and the digital filter 100 uses 1152 coefficients to represent the frequency-domain transfer function H_{RX}(ω).

In one example, repeated calculations of pseudorandom phase offsets and, in the second implementation, pseudorandom amplitude factors, could be made. The deterministic phase mapping for a discrete frequency ω[i] (“i” is an index) could be expressed as P(ω[i])=exp(j ψ_{ω[i]}), and the deterministic phase de-mapping for the discrete frequency ω[i] could be expressed as P(ωᵢ)⁻¹=exp(−j ψ_{ωi}), where a phase offset ψ_{ω[i]} for the discrete frequency ω[i] is given by ψ_{ω[i]}=rand[0, 2π), and this calculation is repeated for all 1152 discrete frequencies. For the second implementation described above, the deterministic amplitude mapping for the discrete frequency ω[i] could be expressed as A(ω[i])=A[i] and the deterministic amplitude de-mapping for the discrete frequency ω[i] could be expressed as A(ωᵢ)⁻¹=1/A[i], where an amplitude factor A[i] for the discrete frequency ω[i] is given by A[i]=rand[0.35, 1], and this calculation is repeated for all 1152 discrete frequencies. A new seed for the random function rand could be set after a predetermined number of calculations, such as after 1152 calculations. In this example, the deterministic phase mapping can be considered spectral phase “encoding” and the deterministic phase de-mapping can be considered spectral phase “decoding”, where the seed of the random function rand is a symmetric “key” used for spectral phase encoding/decoding. In this example, the deterministic amplitude mapping can be considered “encoding” noise and the deterministic amplitude de-mapping can be considered “decoding” noise, where the seed of the random function rand is a symmetric “key” used for encoding/decoding noise.

The lower end of the range of random numbers for the amplitude factor could be a programmable value that is adjusted for optical network system and span design (for example, number of fiber spans, the span loss, FEC gain, modulation format, etc.). The longer the worse-case route—that is, the greater the number of lossy spans (based on a given sensitivity of the receiver 54), the higher the programmable value due to less margin SNR in the specific system.

In another example, a long pseudo-random bit stream could be generated with a single value—such as one byte—for each of the discrete frequencies. This would produce 1152 pseudo-random bytes (8-bit unsigned values). A phase offset ψ_{ω[i]} for a discrete frequency ω[i] and, in the second implementation, an attenuation factor A[i] for the discrete frequency ω[i] could be calculated in a similar manner as described above for the phase offset key (for example, one unsigned byte per discrete frequency) from the pseudo-random byte corresponding to the index i. The deterministic phase mapping for the discrete frequency ω[i] could be expressed as P(ω[i])=exp(j ψ_{ωi}), and the deterministic phase de-mapping for the discrete frequency ω[i] could be expressed as P(ωᵢ)⁻¹=exp(−j ψ_{ωi}). For the second implementation described above, the deterministic amplitude mapping for the discrete frequency ω[i] could be expressed as A(ω[i])=A[i] and the deterministic amplitude de-mapping for the discrete frequency ω[i] could be expressed as A(ω)⁻¹=1/A[i]. In this example, the deterministic phase mapping can be considered spectral phase “encoding” and the deterministic phase de-mapping can be considered spectral phase “decoding”, where the long pseudo-random bit stream is a symmetric “key” used for spectral phase encoding/decoding. In this example, the deterministic amplitude mapping can be considered “encoding” noise and the deterministic amplitude de-mapping can be considered “decoding” noise, where the long pseudo-random bit stream is a symmetric “key” used for encoding/decoding noise.

Any suitable key generation and/or key distribution scheme may be employed to ensure that the “key” used for encoding at the transmitter 14 is identical to the “key” used for decoding at the receiver 54.

The deterministic phase mapping and, in some versions, the deterministic amplitude mapping, use real number multiplication and division, implemented using fixed-point mathematics, or integer multiplication with word growth, clipping/scaling. If the coefficients of H_{PRE}(ω) and R(ω) are denoted H_{PRE}(ω[i]) and R(ω[i]), respectively, the “encoding” can be effected by multiplying one or both sets of those coefficients by P(ω[i]) and, in some versions, also by A[i].

The deterministic phase de-mapping and, in some versions, the deterministic amplitude de-mapping, use real number multiplication and division, implemented using fixed-point mathematics, or integer multiplication with word growth, clipping/scaling. If the coefficients of H_{POST}(ω) are denoted H_{POST}(ω[i]), the “decoding” can be effected by multiplying those coefficients by P(ω[i])⁻¹ and, in some versions, also by A(ω[i])⁻¹.

This multiplication and division can be contrasted with the exclusive OR (XOR) mod 2 addition of data bits with a key employed in some conventional cryptographic algorithms.

For cases where the digital filter 50 was designed for a purpose other than obfuscation and is modified as proposed in this document to introduce the obfuscation function, the digital filter 50 combines the function of encoding with other functions, for example, one or more of impairment pre-compensation, calibration of analog and/or RF components, and pre-distortion. For cases where the digital filter 100 was designed for a purpose other than obfuscation and is modified as proposed in this document to remove the obfuscation function, the digital filter 100 combines the function of decoding with other functions, for example, impairment post-compensation.

The coherent receiver has feedback control loops to track the changes in state of polarization, polarization mode dispersion and polarization dependent loss in the fiber and amplifiers and compensate for it. Adding pseudo random phase and amplitude noise will disrupt the functioning of the feedback loops and make it impossible for the eavesdropping receiver to track the channels in real time.

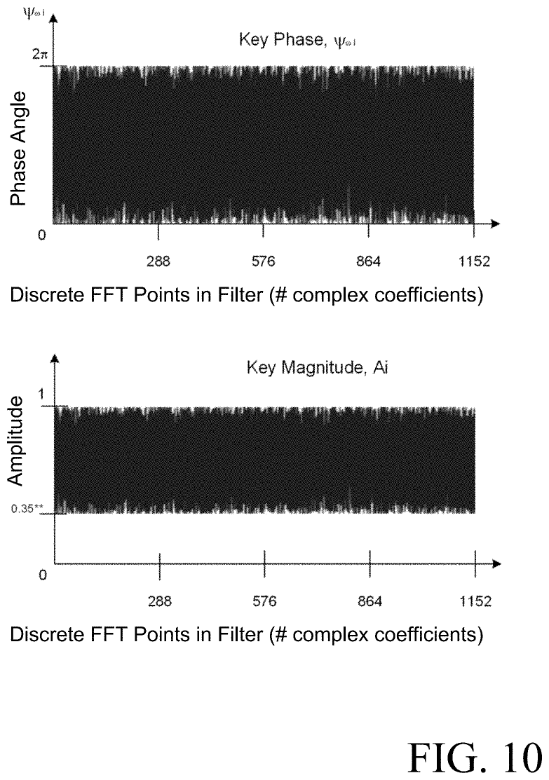

FIG. 10 illustrates example deterministic phase offset results and example deterministic amplitude mapping results;

In the case of a coherent optical communications system, the deterministic amplitude mapping although applied through multiplication may appear to the receiver as additive Gaussian white noise (AGWN) or Amplified Spontaneous Emission (ASE) noise.

The deterministic amplitude mapping that is applied will enhance or attenuate the drive signals that are used to generate the modulated carrier signal 16. The maximum enhancement or attenuation value is limited by the available system margin. The amount of excess margin is reflected by the signal-to-noise ratio (SNR) of the receiver. This may be communication to the transmitter device from the receiver device. Alternatively, if the link is symmetric, the transmitter device may be able to estimate the SNR from its local receiver.

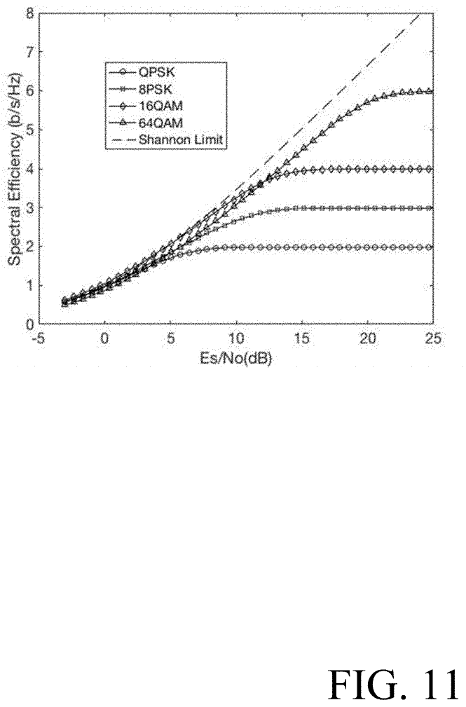

For further levels of concealment, FEC encoding can suppress the required SNR with a tradeoff of reduced payload spectral efficiency, and artificial noise can be added for operation over links with sufficient residual margin at the receiver. FIG. 11 illustrates achievable payload spectral efficiency with soft decision forward error correction (FEC) for different constellation cardinalities as a function of symbol energy to noise ratio (E_{S}/N₀).

Employing probabilistic constellation shaping (PCS) to achieve a Gaussian or super-Gaussian probability distribution of visitation probabilities for symbols in a non-binary constellation (that is, a constellation that maps more than 1 bit to a symbol) together with a digital FIR filter or a digital IIR filter to perform deterministic phase mapping may provide a significant level of security in coherent communication systems. The reason is that, under these conditions, a FIR/IIR digital decoder does not have any metric or any parameter to monitor for convergence, and well-known algorithms such as constant modulus algorithm (CMA) are unable to determine the precise filter used to introduce the deterministic phase mapping at the transmitter DSP. The underlying modulation structure and the information bits are concealed or obfuscated to the point that only detailed, a priori knowledge of the digital FIR or IIR filter's coefficients will enable proper convergence and determination of the underlying, non-binary stream of symbols.

Accordingly, deterministic phase mapping and de-mapping as described above may provide a significant level of security where the functionality of the transmitter DSP 18 includes probabilistic constellation shaping (PCS) 46 and bit-to-symbol mapping 42 according to a non-binary constellation (that is a constellation that maps more than 1 bit to a symbol, such as QPSK, 16-QAM, etc.), and the functionality of the receiver DSP 78 includes symbol-to-bit de-mapping 88 according to the non-binary constellation and inverse PCS 92. Such functionality is illustrated in FIG. 4 and FIG. 5, and in FIG. 8 and FIG. 9.

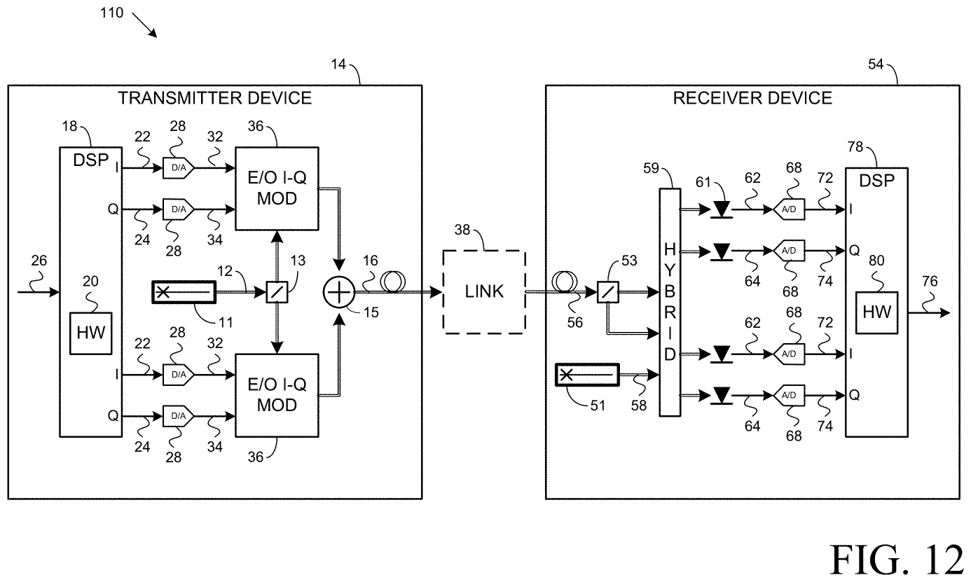

FIG. 12 illustrates an example coherent optical communications system 110 that uses polarization-division multiplexing (PDM). The coherent optical communications system 110 is a specific example of the coherent communications system 10 illustrated in FIG. 1.

In this example, the transmitter device 14 comprises a laser 11 to produce the optical carrier signal 12, a polarization beam splitter 13 to split the optical carrier signal 12 into two orthogonally-polarized components, and a polarization beam combiner 15. The I/Q modulator and up-converter 36 is implemented as two electrical-to-optical modulators 36 (for example, Mach-Zehnder modulators). One of the electrical-to-optical modulators 36 is driven by a pair of the in-phase (I) and quadrature (Q) analog drive signals 22, 24 to modulate one of the orthogonally-polarized components of the optical carrier signal 12, thereby generating a modulated polarized optical signal. The other of the electrical-to-optical modulators 36 is driven by another pair of the I and Q analog drive signals 22, 24 to modulate the other of the orthogonally-polarized components of the carrier signal, thereby generating another modulated polarized optical signal. The polarization beam combiner 15 combines the two modulated polarized optical signals, thereby yielding the modulated optical carrier signal 16 for transmission on the link 38. The transmitter DSP 18 generates the pairs of the I and Q digital drive signals 22, 24 from the information bits 26.

In this example, the receiver device 54 comprises a laser 51 to produce the local version 58 of the optical carrier signal 12, and a polarization beam splitter 53 to split the received modulated carrier signal 56 into two orthogonally-polarized components. The mixer and down-conversion module 60 are implemented by an optical hybrid 59 and photodetectors 61.

In this example, the link 38 is an optical link 38 that may comprise one or more of optical fibers, optical amplifiers, repeaters, WSS nodes, OADMs, ROADMs, etc.

In the case of a coherent optical communications system, the underlying baseband signals may have bit rates of 40 Gbps, 100 Gbps, 200 Gbps, 400 Gpbs, or higher. The symbol rates with two polarizations may range between 30 Gbaud and 80 Gbaud, or higher. (In contrast, full-rate voice channels are in the kilohertz range, such as approximately 13 kbps, 56 kbps in V.90 modems.) Thus if the digital filter 50 and the digital filter 100 are implemented as FIR filters, the FIR filters are applied to much higher bandwidth signals than in the case of using FIR filters for concealing voice signals.

The scope of the claims should not be limited by the details set forth in the examples, but should be given the broadest interpretation consistent with the description as a whole.

1. A method for concealing information conveyed by a modulated carrier signal from a transmitter device to a coherent receiver device, the method comprising:
at the transmitter device
using a transmitter digital signal processor (DSP) to generate digital drive signals from information bits, including selecting symbols of a discrete data constellation and using a digital filter implemented in the transmitter DSP to introduce pseudo-random deterministic changes in phase or both phase and amplitude into the digital drive signals such that the discrete data constellation is remapped into a continuous signal without identifiable constellation points;
converting the digital drive signals to respective analog drive signals;
driving one or more modulators with the analog drive signals to modulate a carrier signal or components of the carrier signal thereby producing the modulated carrier signal; and
transmitting the modulated carrier signal; and
at the receiver device
receiving a distorted version of the modulated carrier signal;
determining analog received signals from the distorted version of the modulated carrier signal;
converting the analog received signals to respective digital received signals; and
using a receiver DSP to process the digital received signals to yield recovered bits, including using a digital filter implemented in the receiver DSP to remove the pseudo-random deterministic changes from the digital received signals.

2. The method as recited in claim 1, wherein the pseudo-random deterministic changes are a function of a key.

3. The method as recited in claim 1, wherein the discrete data constellation is a non-binary constellation.

4. The method as recited in claim 1, wherein the digital filter implemented in the transmitter DSP applies pre-compensation of a physical-layer impairment.

5. The method as recited in claim 1, wherein the digital filter implemented in the receiver DSP applies post-compensation of a physical-layer impairment.

6. The method as recited in claim 1, wherein a deterministic change in amplitude is determined at least in part by available margin.

7. The method as recited in claim 1, wherein functionality of the transmitter DSP includes probabilistic constellation shaping and functionality of the receiver DSP includes inverse probabilistic constellation shaping.

8. The method as recited in claim 1, wherein functionality of the transmitter DSP includes scrambling and functionality of the receiver DSP includes descrambling.

9. A transmitter device comprising:
a digital signal processor (DSP) operative to generate digital drive signals from information bits, the DSP operative to select symbols of a discrete data constellation and to use a digital filter implemented in the DSP to introduce pseudo-random deterministic changes in phase or both phase and amplitude into the digital drive signals such that the discrete data constellation is remapped into a continuous signal without identifiable constellation points;
digital-to-analog converters operative to convert the digital drive signals to respective analog drive signals; and
one or more modulators operative to modulate a carrier signal or components of the carrier signal with the analog drive signals to produce a modulated carrier signal that conveys the information bits.

10. The transmitter device as recited in claim 9, wherein the pseudo-random deterministic changes are a function of a key.

11. The transmitter device as recited in claim 9, wherein the discrete data constellation is a non-binary constellation.

12. The transmitter device as recited in claim 9, wherein the digital filter implemented in the DSP is operative to apply pre-compensation of a physical-layer impairment.

13. The transmitter device as recited in claim 9, wherein functionality of the DSP includes forward error correction (FEC) encoding.

14. The transmitter device as recited in claim 9, wherein functionality of the DSP includes probabilistic constellation shaping.

15. A coherent receiver device comprising:
a mixer and down-conversion module operative to mix a received modulated carrier signal with a local version of an unmodulated carrier signal and operative to output analog received signals;
analog-to-digital converters operative to convert the analog received signals to respective digital received signals, wherein the digital received signals are indistinguishable from random noise; and
a digital signal processor (DSP) operative to process the digital received signals to yield recovered bits, the DSP operative to use a digital filter implemented in the DSP to remove pseudo-random deterministic changes in phase or both phase and amplitude from the digital received signals.

16. The coherent receiver device as recited in claim 15, wherein the pseudo-random deterministic changes are a function of a key.

17. The coherent receiver device as recited in claim 15, wherein the DSP is operative to de-map symbols of a non-binary constellation to forward error correction (FEC) encoded bits.

18. The coherent receiver device as recited in claim 15, wherein the digital filter implemented in the DSP applies post-compensation of a physical-layer impairment.

19. The coherent receiver device as recited in claim 15, wherein functionality of the DSP includes forward error correction (FEC) decoding and error correction.

20. The coherent receiver device as recited in claim 15, wherein functionality of the DSP includes inverse probabilistic constellation shaping.
